(19) United States
(12) Patent Application Publication
(10) Pub. No.: US 2025/0118023 A1
(43) Pub. Date: Apr. 10, 2025

(54) METHOD FOR GENERATING 3D OBJECT

(71) Applicant: SOULX CO., LTD., Seoul (KR)

(72) Inventor: YOUNGTAECK HWANG, Seoul (KR)

(21) Appl. No.: 18/533,334

(22) Filed: Dec. 8, 2023

(30) Foreign Application Priority Data
Oct. 10, 2023 (KR) 10-2023-0134465

(51) Int. Cl. G06T 17/20; G06T 13/20; H04L 9/08

(52) U.S. Cl. CPC G06T 17/20; G06T 13/20; H04L 9/0825

(57) ABSTRACT

A method of sharing a 3D asset performed by at least one processor include obtaining first type data including an FBX file, and second type data including textures, normal maps, metallic information, and roughness information, based on an input 3D asset, generating a procedural mesh using a first model based on the first type data, and generating a 3D object using a second model based on the procedural mesh and the second type data.

### CROSS-REFERENCE TO RELATED APPLICATION AND CLAIM OF PRIORITY

This application claims the benefit under 35 USC § 119 of Korean Patent Application No. 10-2023-0134465, filed on Oct. 10, 2023, in the Korea Intellectual Property Office, the entire disclosure of which is incorporated herein by reference for all purposes.

### BACKGROUND

### 1. Technical Field

The present disclosure relates to a platform that may extend the use of 3D assets to more diverse fields.

### 2. Background Art

XROOM is a program that allows users to create 3D effects conveniently when creating video content or broadcasting private broadcasts. Previously, XROOM required the cumbersome task of preparing and instantiating resources such as textures, materials, and vertices in advance to utilize 3D assets. Furthermore, these 3D assets were mainly targeted at engineering and 3D development professionals and modelers, and their use by general users in broadcasting and 3D spaces was limited. Therefore, there is a need for a platform that may overcome these limitations and expand the use of 3D assets to more diverse fields.

### SUMMARY

The present disclosure may have the following goals.

The present disclosure aims to create user-friendly 3D objects based on 3D assets. In addition, the present disclosure seeks to convert and manipulate 3D assets into 3D objects in order to utilize the 3D assets in a runtime environment. Furthermore, the present disclosure seeks to encrypt the 3D assets to secure the 3D assets between the marketplace and the client.

A method of sharing a 3D asset performed by at least one processor for solving the aforementioned tasks may include obtaining first type data including a filmbox (FBX) file, and second type data including textures, normal maps, metallic information, and roughness information, based on an input 3D asset, generating a procedural mesh using a first model based on the first type data, and generating a 3D object using a second model based on the procedural mesh and the second type data.

According to an example embodiment, the input 3D asset may include a 3D asset that has been decrypted from an encrypted 3D asset, and the decrypted 3D asset may be generated based on an operation of obtaining the encrypted 3D asset from a marketplace and an operation of decrypting the encrypted 3D asset by a client using a secret key.

According to an example embodiment, the marketplace may include the encrypted 3D asset, and the encrypted 3D asset may include the operation of obtaining the input 3D asset from a 3D modeler, and the operation of generating the encrypted 3D asset using a public key based on the input 3D asset.

According to an example embodiment, the operation of generating the encrypted 3D asset using a public key based on the input 3D asset may include generating a 3D asset encrypted with an RSA encryption algorithm using a public key based on the input 3D asset, and the operation of decrypting the encrypted 3D asset by the client using the secret key may include generating a 3D asset decrypted with an RSA decryption algorithm using a secret key based on the encrypted 3D asset.

According to an example embodiment, the generating a procedural mesh using a first model based on the first type data may include extracting a node hierarchy of the 3D object from the FBX file using the first model, obtaining a transformation matrix based on the node hierarchy, obtaining, based on the transformation matrix, a procedural coordinate system, and obtaining a procedural texture, and generating, based on the procedural coordinate system and the procedural texture, the procedural mesh.

According to an example embodiment, the FBX file may include header data, take data, animation curve data, FBX meshes, and FBX textures.

According to an example embodiment, the generating a 3D object using a second model based on the procedural mesh and the second type data may include generating a 3D object using the second model based on the procedural mesh and the second type data, and adjusting shadows and light sources of the 3D object.

According to an example embodiment, the first model may include Assimp, and the second model may include Unreal Engine.

According to an example embodiment, the method may further include delivering the 3D object to a terminal including a program related to the 3D project.

According to an example embodiment, the program related to the 3D project may include an operation of manipulating the 3D object in the runtime environment and an operation of interacting with the 3D object in the runtime environment.

A server for solving the aforementioned tasks may include at least one processor, and a memory, wherein the at least one processor may be configured to obtain first type data including an FBX file, and second type data including textures, normal maps, metallic information, and roughness information, based on an input 3D asset, generate a procedural mesh using a first model based on the first type data, and generate a 3D object using a second model based on the procedural mesh and the second type data.

A computer program stored on a computer-readable storage medium for solving the aforementioned tasks, wherein the program, when executed by at least one processor, causes the at least one processor to perform operations to generate a 3D object, the operations including obtaining first type data including an FBX file, and second type data including textures, normal maps, metallic information, and roughness information, based on an input 3D asset, generating a procedural mesh using a first model based on the first type data, and generating a 3D object using a second model based on the procedural mesh and the second type data.

According to an example embodiment, in the computer program stored on a computer-readable storage medium, the input 3D asset may include a 3D asset that has been decrypted from an encrypted 3D asset, and the decrypted 3D asset may be generated based on an operation of obtaining the encrypted 3D asset from a marketplace and an operation of decrypting the encrypted 3D asset by a client using a secret key.

A terminal for solving the aforementioned tasks may include at least one processor, and a memory, wherein the at least one processor may be configured to manipulate the 3D object in the runtime environment and interact with the 3D object in the runtime environment, and wherein the 3D object causes the server to obtain first type data including an FBX file, and second type data including textures, normal maps, metallic information, and roughness information, based on an input 3D asset, generate a procedural mesh using a first model based on the first type data, and generate a 3D object using a second model based on the procedural mesh and the second type data.

According to the present disclosure, the following effects may be produced.

According to the present disclosure, with respect to a 3D asset, a 3D object may be created and a 3D object may be adjusted so that a user may easily create content associated with the 3D object.

For example, instantiation was required to use previous 3D assets as 3D objects, but by using a method according to an example embodiment of the present disclosure, a 3D object may be generated from a 3D asset.

Here, the 3D asset may be encrypted to ensure security during the transmission and reception between the marketplace and the client.

### BRIEF DESCRIPTION OF THE DRAWINGS

FIG. 1 is a schematic block diagram of a structure of a server according to an example embodiment of the present disclosure.

FIG. 2 is a schematic view illustrating a method of creating a 3D object of the present disclosure.

FIG. 3 is a schematic view of a method of creating multiple types of 3D objects using the 3D asset platform of the present disclosure.

FIG. 4 is a schematic view illustrating in relative detail a method of creating a 3D object of the present disclosure.

FIG. 5 is a flowchart illustrating a method according to an example embodiment of the present disclosure.

FIG. 6 is a diagram illustrating a distance between a camera and a display device according to an example embodiment of the present disclosure.

FIG. 7 is a diagram illustrating a virtual space according to an example embodiment of the present disclosure.

FIG. 8 is a diagram illustrating a planar image in virtual space according to an example embodiment of the present disclosure.

FIGS. 9A and 9B are a diagram illustrating the composition of a planar image and a virtual space image according to an example embodiment of the present disclosure.

FIG. 10 is a diagram illustrating a control box utilized for compositing a planar image in a virtual space according to an example embodiment of the present disclosure.

FIG. 11 is a normal and schematic view of a computing environment in which the embodiments of the present disclosure may be implemented.

### DETAILED DESCRIPTION

Various example embodiments will now be described with reference to drawings. In the present disclosure, various descriptions are presented to provide appreciation of the present disclosure. However, it is apparent that the example embodiments may be executed without the specific description.

“Component”, “module”, “system”, and the like which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a server and the server may be the components. One or more components may reside in the processor and/or the execution thread. One component may be localized in one computer. One component may be distributed among two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

A term “or” intends to mean comprehensive “or”, not exclusive “or”. That is, unless otherwise specified or when it is unclear in context, “X uses A or B” intends to mean one of the natural comprehensive substitutions. That is, when X uses A, X uses B, or X uses both A and B, “X uses A or B” may be applied to any one among the cases. Further, a term “and/or” used in the present disclosure shall be understood to designate and include all of the possible combinations of one or more items among the listed relevant items.

A term “include” and/or “including” shall be understood as meaning that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear that a single form is indicated in context, the singular shall be construed to generally mean “one or more” in the present disclosure and the claims.

The term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the example embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented example embodiments is provided so as for those skilled in the art to use or carry out the present disclosure. Various modifications of the example embodiments will be apparent to those skilled in the art. General principles defined herein may be applied to other example embodiments without departing from the scope of the present disclosure. Therefore, the present disclosure is not limited to the example embodiments presented herein. The present disclosure shall be interpreted within the broadest meaning range consistent to the principles and new characteristics presented herein.

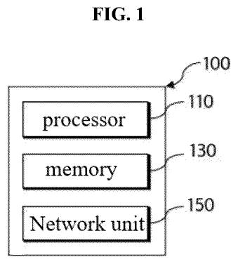

The configuration of a server 100 illustrated in FIG. 1 is merely a simplified example. In an example embodiment of the present disclosure, the server 100 may include other configurations for performing a computing environment of the server 100, and only some of the disclosed configurations may also configure the server 100.

The server 100 may include a processor 110, a memory 130, and a network unit 150.

The processor 110 may be formed of one or more cores, and may include a processor, such as a central processing unit (CPU), a general purpose graphics processing unit (GPGPU), and a tensor processing unit (TPU) of the server, for performing a data analysis and deep learning. The processor 110 may read a computer program stored in the memory 130 and perform data processing for machine learning according to an example embodiment of the present disclosure. The processor 110 may perform operations to train a neural network model according to an example embodiment of the present disclosure. The processor 110 may perform computations for training the neural network model, such as processing input data for training in deep learning (DL), extracting features from the input data, computing errors, and updating weights of the neural network model using backpropagation. At least one of the CPU, GPGPU, and TPU of the processor 110 may process training of the neural network model. For example, the CPU and GPGPU may train the neural network model and classify data using the neural network model together. Further, in an example embodiment of the present disclosure, processors of a plurality of servers may be used together to train the neural network model and classify data using the neural network model. In addition, the computer program executed on the server according to an example embodiment of the present disclosure may be a CPU, GPGPU or TPU executable program.

According to an example embodiment of the present disclosure, the memory 130 may store a predetermined type of information generated or determined by the processor 110 and a predetermined type of information received by a network unit 150.

According to an example embodiment of the present disclosure, the memory 130 may include at least one type of storage medium among a flash memory type, a hard disk type, a multimedia card micro type, a card type of memory (for example, an SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk. The server 100 may also be operated in relation to web storage performing a storage function of the memory 130 on the Internet. The description of the foregoing memory is merely illustrative, and the present disclosure is not limited thereto.

The network unit 150 according to an example embodiment of the present disclosure may utilize a variety of wired communication systems, such as Public Switched Telephone Network (PSTN), x Digital Subscriber Line (xDSL), Rate Adaptive DSL (RADSL), Multi Rate DSL (MDSL), Very High Speed DSL (VDSL), Universal Asymmetric DSL (UADSL), High Bit Rate DSL (HDSL), and local area network (LAN).

In addition, the network unit 150 disclosed herein may utilize a variety of wireless communication systems, such as Code Division Multi Access (CDMA), Time Division Multi Access (TDMA), Frequency Division Multi Access (FDMA), Orthogonal Frequency Division Multi Access (OFDMA), Single Carrier-FDMA (SC-FDMA), and other systems.

The network unit 150 in the present disclosure may be configured regardless of its communication mode, such as a wired mode and a wireless mode, and may be configured of various communication networks, such as a Personal Area Network (PAN) and a Wide Area Network (WAN). Further, the network may be the publicly known World Wide Web (WWW), and may also use a wireless transmission technology used in PAN, such as Infrared Data Association (IrDA) or Bluetooth. The technologies described in the present disclosure may be used in other networks mentioned above.

As to be described herein, the server 100 of the present disclosure may operate the marketplace 220 and client 240 on a Software as Service (SaaS) or on-premises basis. As used herein, SaaS may refer to a business and technology model in which software services are accessed via the web instead of purchasing or installing software. In this model, the software is hosted via cloud, and the server 100 may connect to the Internet via a web browser to use the software. On the other hand, on-premises may refer to installing and operating software, hardware, or technical solutions in an organization's or individual's local environment, such as their own data center or local server, and using software contained in the server 100's own storage.

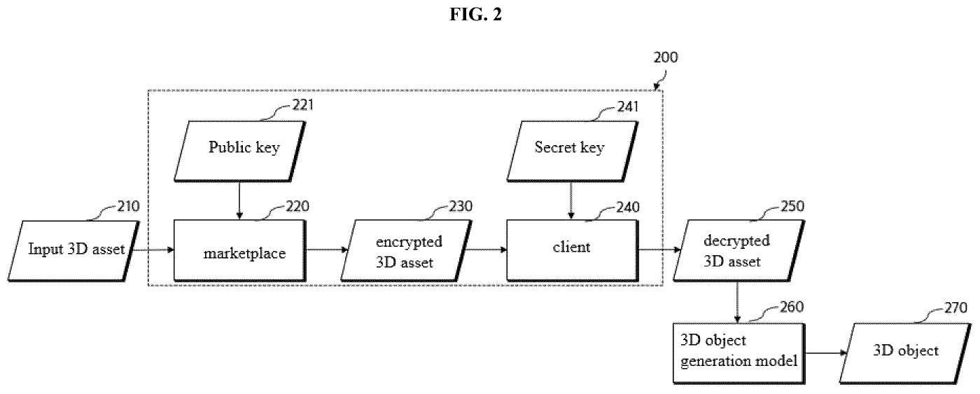

FIG. 2 is a schematic view illustrating a method of creating a 3D object of the present disclosure.

Example embodiments of a method of creating a 3D object based on an input 3D asset performable by the processor 110 will now be described with reference to FIG. 2. The reference numeral 200 in FIG. 2 refers to a 3D asset platform, wherein when the processor 110 receives an input 3D asset 210 from a 3D asset modeler, it may RSA encrypt the 3D asset based on a public key 221 and store it in a marketplace 220. The marketplace 220 may take the form of a community of sorts, or an archive, or an app store, where 3D assets may be bought, sold, or displayed for sharing. The processor 110 may provide the encrypted 3D asset 230 to the user's client 240 upon request from a user using the marketplace 220. The user's client 240 holds a secret key 241 that may decrypt the RSA cipher. The processor 110 may then cause the client 240 to generate the decrypted 3D asset 250 based on the encrypted 3D asset 230. The processor 110 may then use the 3D object generation model 260 to generate a 3D object 270 based on the decrypted 3D asset in a form that is freely available to the user.

For example, 3D assets traded between users and 3D modelers in the marketplace 220 may be protected by strong encryption until they reach the client 240. When a 3D modeler uploads a 3D asset to the marketplace, the processor 110 may receive it and generate an RSA key pair, a public key 221 and a secret key 241. The public key may be used to encrypt the asset, and the secret key may be required to decrypt the asset. The asset uploaded by the 3D worker may then be encrypted by the processor 110 using the public key 221. During this process, the data in the asset may be encrypted and stored based on the public key 221.

The encrypted 3D asset 230 may be stored in AWS S3 storage. When the user downloads the asset, the processor 110 may cause the client 240 to decrypt the asset using the RSA secret key. Here, the asset may be decrypted using the RSA algorithm and restored to the original 3D asset.

In terms of effectiveness, traditional programs such as XROOM required the cumbersome task of preparing and instantiating resources such as textures, materials, and vertices in advance to utilize 3D assets. These 3D assets were mainly targeted at engineering and 3D development professionals and modelers, and their use by general users in broadcasting and 3D spaces was limited. Methods according to example embodiments of the present disclosure may simplify the process of performing cumbersome tasks and preparing resources to utilize the 3D assets. Furthermore, utilization by general users and in broadcasting and 3D spaces may be enabled, and 3D assets may be utilized in a runtime environment.

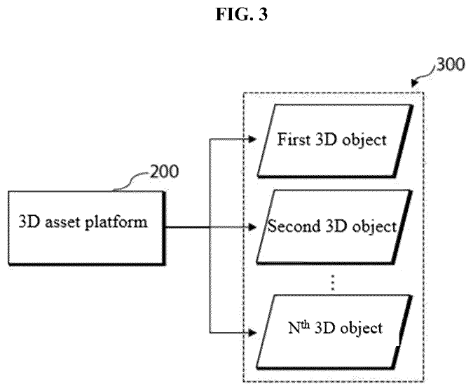

FIG. 3 is a schematic view of a method of creating multiple types of 3D objects using the 3D asset platform of the present disclosure.

The foregoing described a 3D asset platform 200 that generates 3D objects. However, the 3D objects may be of different types depending on the program requiring the 3D objects and may not be compatible with each other. Therefore, the processor 110 may cause the 3D asset platform 200 to generate X number of 3D objects 300 based on X number of program settings, rather than generating a single type of 3D object. For example, in the process of generating a procedural mesh using a first model based on a first type data including an FBX file based on an input 3D asset, the processor 110 may use the first model to extract a node hierarchy of a 3D object from the FBX file, obtain a transformation matrix based on the node hierarchy, obtain a procedural coordinate system based on the transformation matrix, obtain a procedural texture, and generate a procedural mesh based on the procedural coordinate system and the procedural texture. In this case, the procedural mesh may be a 3D object of various forms with a combination of additional materials.

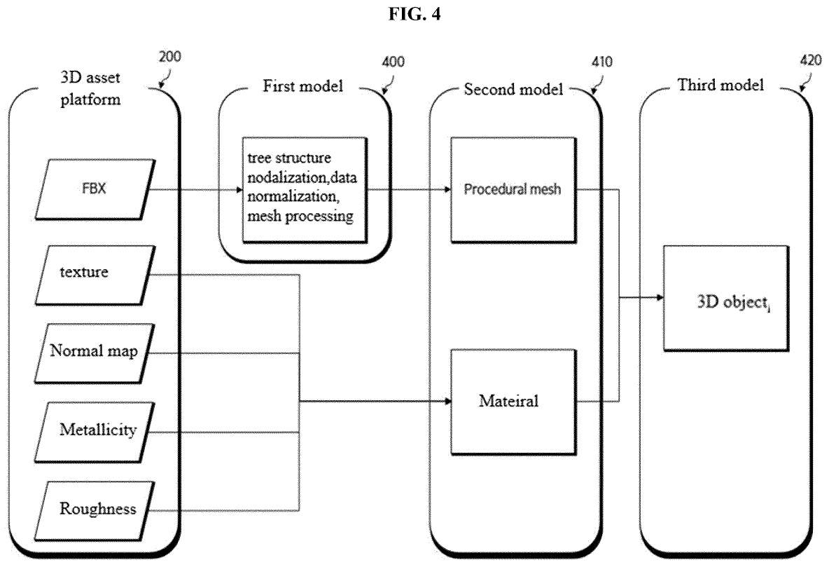

FIG. 4 is a schematic view illustrating in relative detail a method of creating a 3D object of the present disclosure.

Referring to FIG. 4, the first type data of the 3D asset platform 200 described above may include data of the FBX type. The FBX type data may include a Header, Definitions, Takes, Animation Curves, and FBX Data. The Header may include basic information and metadata about the file, the Definitions may include definitions of objects such as 3D models, animations, materials, and cameras, the Takes may be used to include versions of different animations or states, the Animation Curves may include curve data defining the animation of the object, and the FBX Data may include actual mesh and texture data for the 3D model. The second type data may include textures, normal maps, metallic information, and roughness information. The processor 110 may then perform tree structure nodalization operations, data normalization operations, and mesh processing operations based on the first data to generate a procedural mesh. Specifically, the processor 110 may generate the procedural mesh by extracting from the FBX a transformation matrix in the form of a nodal hierarchy structure via Assimp, storing it in a coordinate system, and loading texture data. At this time, the procedural mesh may include vertex positions, normal vectors, UV coordinates, and tangent information to represent the 3D object. The processor 110 may then generate a 3D object in the third model 420 using the second model 410 based on the procedural mesh generated based on the first data and the materials generated based on the second data.

In this case, the first model may include an Assimp model, the second model 410 may include an Unreal engine model, and the third model may include an XROOM program. Assimp stands for “Open Asset Import Library” and is an open source library for importing and loading 3D model data in various formats. Assimp supports a variety of 3D file formats and may convert 3D model data into a structure that may be used in applications. Further, the Unreal engine model is a high-performance 3D game engine and simulation engine, which may provide high quality graphics and a variety of features including a physics engine, artificial intelligence, sound, and networking systems. Finally, the XROOM program may provide for the use of 3D objects in the video during runtime, and may be utilized for personal broadcasts, lectures, and the like.

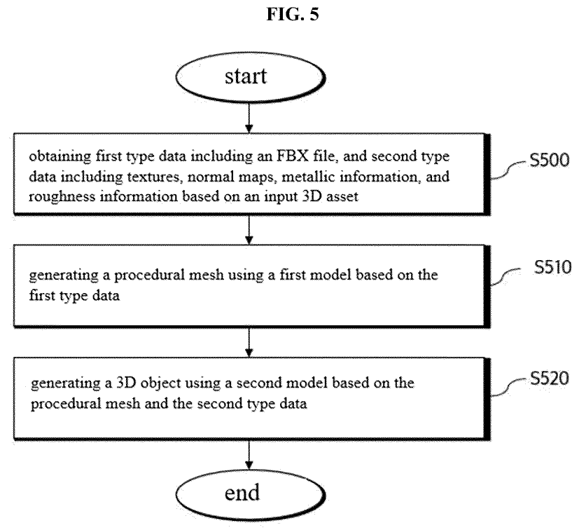

FIG. 5 is a flowchart illustrating a method according to an example embodiment of the present disclosure.

A schematic flow of the present disclosure will now be described with reference to FIG. 5.

First, according to an example embodiment, an operation (S500) in which the processor 110 obtains, based on an input 3D asset, first type data including an FBX file, and second type data including textures, normal maps, metallic information, and roughness information, an operation (S510) in which the processor 110 generates a procedural mesh using a first model based on the first type data, and an operation (S520) in which the processor 110 generates a 3D object using a second model based on the procedural mesh and the second type data may be included.

Here, the input 3D asset may include a 3D asset that has been decrypted from an encrypted 3D asset, and the decrypted 3D asset may be generated based on an operation by the processor 110 of obtaining the encrypted 3D asset from a marketplace and an operation by the processor 110 causing the client to decrypt the encrypted 3D asset using a secret key

In addition, the marketplace may include the encrypted 3D asset, and the encrypted 3D asset may include the operation by the processor 110 of obtaining the input 3D asset from a 3D modeler, and the operation by the processor 110 of generating the encrypted 3D asset using a public key based on the input 3D asset.

Here, the operation by the processor 110 of generating the encrypted 3D asset using a public key based on the input 3D asset may include generating a 3D asset encrypted with an RSA encryption algorithm using a public key based on the input 3D asset, and the operation by the processor 110 of having the client decrypt the encrypted 3D asset using the secret key may include generating a 3D asset decrypted with an RSA decryption algorithm using a secret key based on the encrypted 3D asset.

Meanwhile, the operation (S510) by the processor 110 of generating a procedural mesh using a first model based on the first type data may include the processor 110 extracting a node hierarchy of the 3D object from the FBX file using the first model, the processor 110 obtaining a transformation matrix based on the node hierarchy, and the processor 110 obtaining, based on the transformation matrix, a procedural coordinate system, and obtaining a procedural texture, and generating, based on the procedural coordinate system and the procedural texture, the procedural mesh.

Here, the FBX file may include header data, take data, animation curve data, FBX meshes, and FBX textures.

The operation (S520) by the processor 110 of generating a 3D object using a second model based on the procedural mesh and the second type data may include the processor 110 generating a 3D object using the second model based on the procedural mesh and the second type data, and the processor 110 adjusting shadows and light sources of the 3D object.

Here, the first model may include Assimp, and the second model may include Unreal Engine.

According to an example embodiment, the method may further include the operation (S530, not illustrated) of the processor 110 delivering the 3D object to a terminal including a program related to the 3D project.

Moreover, the program related to the 3D project may include an operation of manipulating the 3D object in the runtime environment and an operation of interacting with the 3D object in the runtime environment.

Meanwhile, the 3D objects may include various objects, such as object objects, background objects, and effect objects. For the object objects, there may be various object objects, such as spaceships, cars, traffic lights, and the like, and the object objects may be grouped by theme. For example, the object objects may be grouped by theme, such as city (e.g. cars, buildings, traffic lights, etc.), nature (e.g. trees, forests, rocks, etc.), sea (e.g. fish, boats, seagulls, etc.), space (e.g. planets, stars, spaceships, etc.), and the like.

The effect objects may be objects that show phenomena/effects such as earthquakes, fire, lightning, and the like, and the background objects may be objects that show the background in the virtual space (e.g. rain, snow, thunder, sea, space, etc.).

According to an example embodiment of the present disclosure, another effect may be implemented when a particular object is matched to a particular background object. For example, if a background object representing an ocean appears in the virtual space (same theme), the processor 110 may actually add movement such as swimming or flying over the ocean to fish objects, seagull objects, and the like associated with the ocean. On the other hand, if a car object appears in the ocean background (different theme), the processor 110 may limit the movement of the car object.

Additionally, when two or more objects are overlapped, the processor 110 may generate a new matching effect. For example, if a user positions a bird object on top of a tree object, a bird may be animated to sit on the tree, and if one pipe object is positioned to overlap another pipe object, the two pipe objects may be connected to each other.

Furthermore, if a fire object (effect object) is positioned to overlap a chair object (object object) in the virtual space, the processor 110 of the server 100 may display the appearance of the chair burning on the screen.

Meanwhile, the process by which the 3D objects are displayed in virtual space will be discussed below.

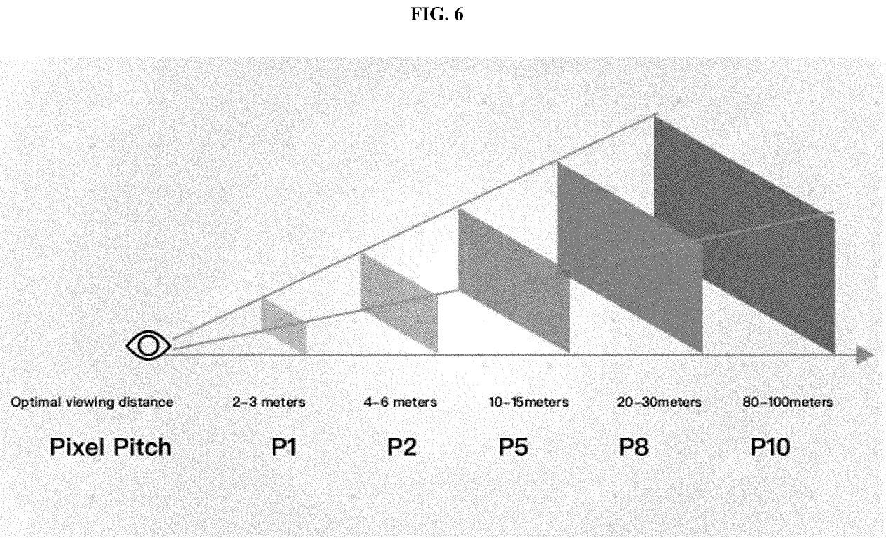

FIG. 6 is a diagram illustrating a distance between a camera and a display device according to an example embodiment of the present disclosure.

Further, the distance between the display device (or subject) and the camera may be determined based on the resolution or pixel pitch of the display device.

As shown in FIG. 6, the wider the spacing of the display device's pixel pitch (distance between LED pixels) or the lower the resolution, the greater the distance between the display device and the camera may be. This is because at lower resolutions (with wider pixel pitch spacing), a longer distance is required to capture natural-looking images.

For example, if the pixel pitch is P2 (e.g. LED pixels are 2 mm apart), the distance between the display device and the camera is 4-6 meters, and if the pixel pitch is P10 (e.g. LED pixels are 10 mm apart), the distance between the display device and the camera may be 80-100 meters.

The processor 110 of the computing device 100 may receive a planar image from a camera photographing the display device. That is, the processor 110 may receive a planar image of a wallpaper displayed on the display device and a subject positioned in front of it.

Here, the planar image corresponds to a size that may include both the current position of the subject and the moving space of the subject, and may generally correspond to the screen size of the display device.

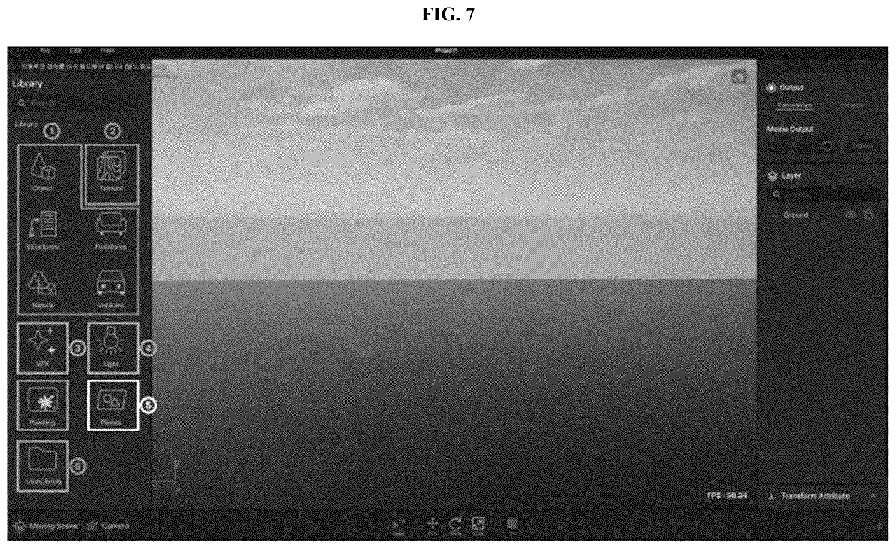

FIG. 7 is a diagram illustrating a virtual space according to an example embodiment of the present disclosure.

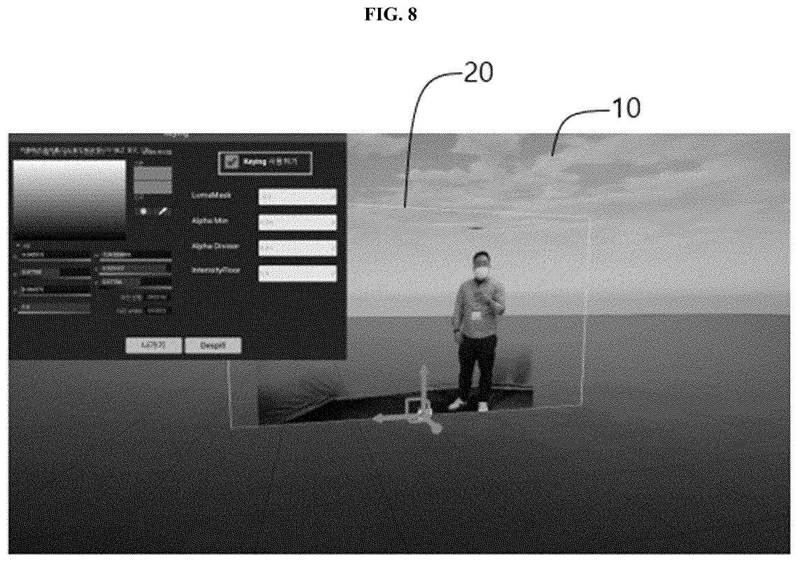

FIG. 8 is a diagram illustrating a planar image in virtual space according to an example embodiment of the present disclosure.

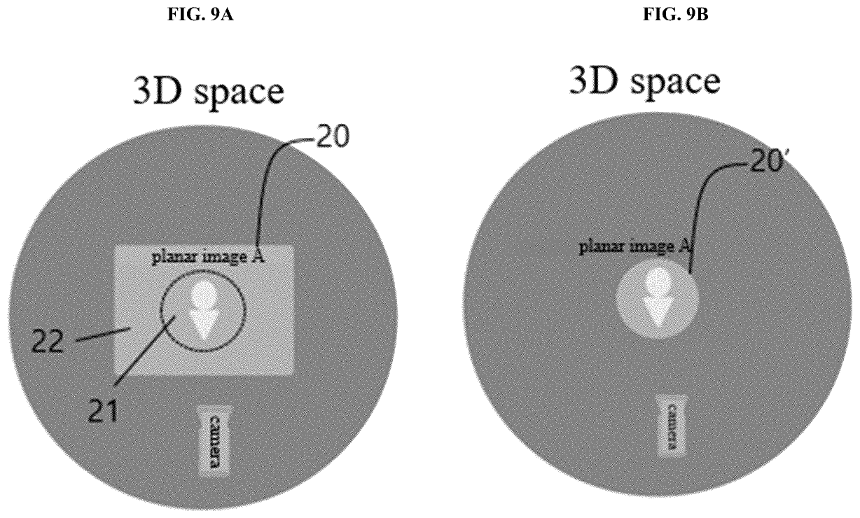

FIGS. 9A and 9B are a diagram illustrating the composition of a planar image and a virtual space image according to an example embodiment of the present disclosure

The processor 110 of the server 100 may composite the received planar image and the virtual space image to output a final image.

Here, the virtual space may include various wallpapers selected by the user. The processor 110 provides editing tools for the user to edit the virtual space, and specifically, various objects (e.g., in the form of buildings, chairs, cars, etc.), textures (e.g., Brick, Steel, Concrete, Wood), visual effects (e.g., fireworks), and various light sources (e.g., light source position on the side, light source position on the top) that may decorate the virtual space may be provided as editing tools. For example, a ship object may be added to a background (virtual space) called the sea, and fireworks, etc. may be added.

Furthermore, in the present disclosure, the virtual space (3D) may be set to be photographed by a virtual camera, and the virtual camera may be set to be located and photograph at any position in the virtual space such as 2D, 3D, and the like. The virtual camera is distinct from a real camera, and by operating the virtual camera, the screen or the like on the virtual space being photographed may be changed.

Further, the processor 110 may position the received planar image in the direction in which the virtual camera is looking. In this case, the planar image may be disposed closer to the virtual space being photographed by the virtual camera, and of course, the location where the planar image is disposed may be determined by user selection.

As shown in FIG. 8, the planar image 20 may be positioned in front of the virtual space 10 relative to the virtual camera (viewing perspective).

Further, in the case of a plurality of cameras, the processor 110 may receive a plurality of planar images 20, and the plurality of planar images 20 may be displayed in real time on the virtual space 10, even in a composite image. The processor 120 may allow a user to select a particular camera and a particular planar image by displaying identifying marks for each of the plurality of cameras.

Furthermore, the processor 110 of the server 100 may match the coordinates of the planar image 20 and the coordinates of the virtual space 10. That is, the processor 110 may obtain a position (e.g. x-coordinate, y-coordinate, height h) at which the planar image 20 is disposed relative to the virtual space 10 from which the entire wallpaper is output, and may output a matching screen based on the position to the display device.

Here, the position at which the planar image 20 is disposed may be set based on the x, y coordinates of one of the points (e.g. center point, corner point) of the planar image 20 and the height (h) of the planar image 20. In some cases, the z-axis coordinate of one of the points rather than the height (h) may be a determining factor for the placement position.

Further, the processor 110 may crop a remaining second area 22 from the planar image, excluding a first area 21 corresponding to the space where the subject is located and the movement space where the subject will move, and composite only the first area 21 with the virtual space image 10 as the planar image 20′ to generate and provide the final image.

Specifically, the subject is movable, and a movable movement space may be preset based on an area of the planar image 20, and the area may be set as the first area 21. The remaining area excluding the first area 21 from the area of the planar image 20 output from the display device may be referred to as the second area 22, and the processor 110 may remove the second area 22 by cropping, and composite only the first area 21 with the virtual space image.

Referring to FIG. 9A, the processor 120 may crop the remaining area 22, leaving only the first area 21 corresponding to the circular shape in the planar image 20, and output the final image by compositing the planar image 20′ corresponding to the first area 21 with the virtual space image (see FIG. 9B).

The periphery of the first area 21 to be composited with the virtual space image may be blurred, so that the boundary between the virtual space image and the planar image 20′ is natural.

Further, the size of the first area 21 to be composited may vary based on the size of the subject and the size of the movement space. Specifically, the larger the size of the subject, the larger the area it occupies, and thus the larger the size of the first area 21 may be. The area occupied by the movement space may also be larger as the size of the subject increases.

Further, according to an example embodiment of the present disclosure, the processor 120 of the computing device 100 may obtain identification information (e.g. ID, fingerprint, iris, etc.) of each of the plurality of subjects, and may pre-learn the individual movement space of each of the subjects, and may pre-store the area occupied based on the body shape (e.g. height) of the subject in the memory, database 130.

Additionally, when the processor 110 recognizes a particular subject, it may provide the first area 21 and the planar image with a size that is matched based on the learned movement space for the particular subject and the body shape of the particular subject via AI.

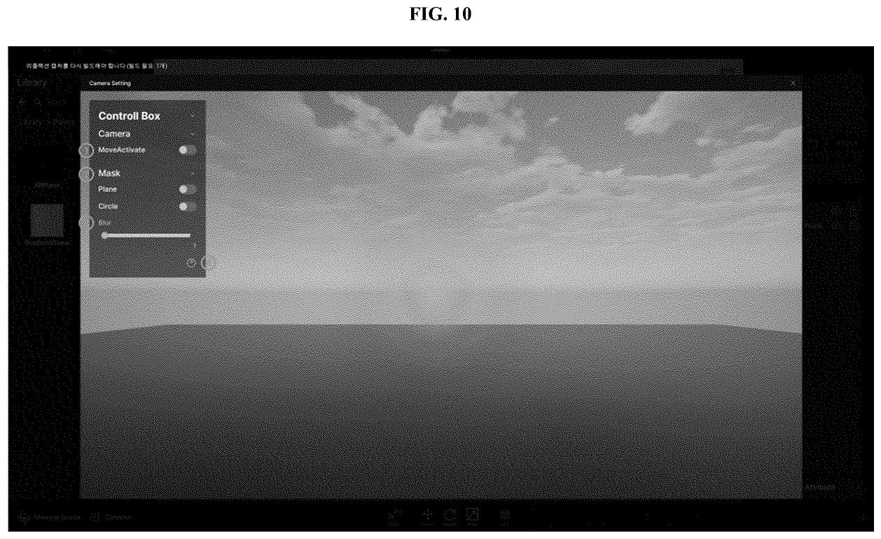

FIG. 10 is a diagram illustrating a control box utilized for compositing a planar image in a virtual space according to an example embodiment of the present disclosure.

According to an example embodiment of the present disclosure, the processor 110 may composite the planar image 20 disposed in the virtual space with the virtual space 10 and output a final image. In doing so, a control box may be utilized, as shown in FIGS. 9A and 9B. Here, the control box may include buttons for activating camera movement, selecting a crop area, selecting a blurring intensity, and the like.

Specifically, the processor 110 may allow the user to control the movement of the camera 400 via the camera movement activation button. That is, the movement of the camera 400 (up, down, left, right) may be controlled via a control box and may be activated/deactivated.

Further, the processor 110 may allow the user to select a rectangular area (Plane) or a circular area (Circle) when selecting the crop area (distinguishing between a first area and a second area).

That is, the processor 110 may select a mask of the remaining first area 21, excluding the second area 22 to be cropped from the planar image 20, as either a rectangle or a circle. Further, the processor 120 may adjust the position, size, and the like of the mask of the first area 21.

Further, the processor 110 may propose a shape, size, or the like of the first area 21 using artificial intelligence (AI) based on the subject's movement, shape, or the like. Specifically, the processor 110 may propose a circle shape as the shape of the first area 21 if the subject's movement (movement space) is below a predetermined area.

Further, the area occupied by the subject may be calculated based on the area of the display device, and the size of the first area 21 may be automatically adjusted and proposed based on the ratio.

Further, the processor 110 may adjust the intensity of blurring (e.g. steps 1-10) for the first area 21 using AI. For example, if the planar image 20 and the virtual space 10 have the same background, the planar image 20 may be composited on the virtual space 10 while proceeding with blurring to a certain degree (e.g. step 2).

On the other hand, if the backgrounds of the planar image 20 and the virtual space 10 are different, the intensity of blurring may be set differently depending on whether the difference in color values at the boundary (e.g., RGB value at the virtual space boundary-RGB value at the planar image boundary) is below a certain value. In other words, the larger the difference, the greater the intensity of blurring.

In addition, for convenience in calculation, the average RGB value of the plurality of pixels on the planar image boundary and the average RGB value of the plurality of pixels on the virtual space boundary may be calculated respectively, and the difference between them may be calculated to determine the intensity of blurring.

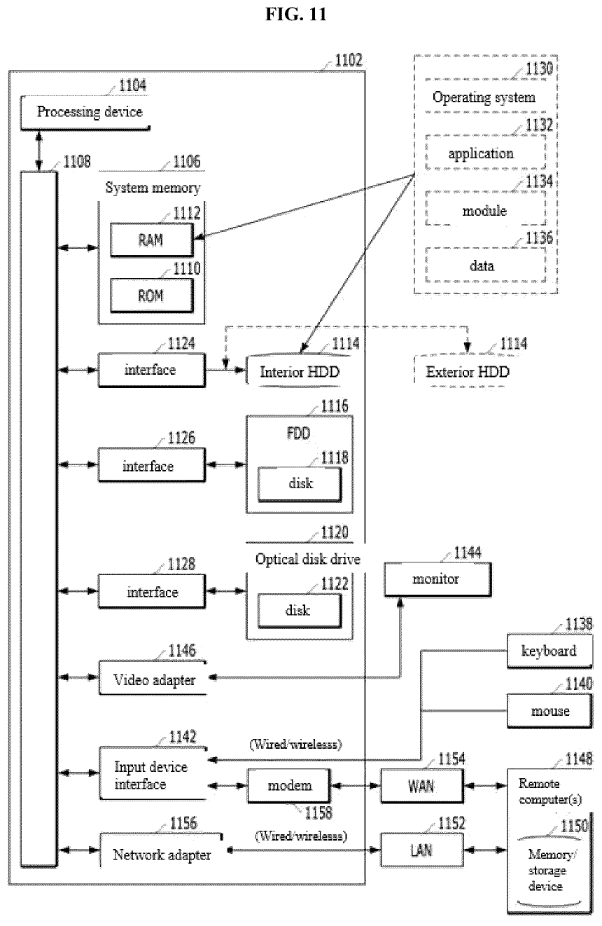

FIG. 11 is a normal and schematic view of a computing environment in which the embodiments of the present disclosure may be implemented.

It is described above that the present disclosure may be generally implemented by the server, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure may be implemented by other computer system configurations including a personal computer, a handheld server, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As not a limit but an example, the computer readable media may include both computer readable storage media and computer readable transmission media. The computer readable storage media include volatile and non-volatile media, temporary or non-temporary media, and movable and non-movable media implemented by a predetermined method or technology for storing information such as a computer readable command, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by configuring or changing at least one of characteristics of the signal so as to encode information in the signal. As not a limit but an example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor or other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable command, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may be cached by the RAM 1112. It will be well appreciated that the present disclosure may be implemented in various operating systems which are commercially usable or a combination of the operating systems.

A user may input commands and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and a Bluetooth wireless technology. Accordingly, communication may be a predefined structure like the network in the related art or just ad hoc communication between at least two devices.

The Wi-Fi enables connection to the Internet, and the like without a wired cable. The Wi-Fi is a wireless technology such as a device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

Those skilled in the art will appreciate that the various illustrative logical blocks, modules, processors, means, circuits, and algorithm operations described in relation to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Additionally, various storage media described herein may represent one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be arranged within the scope of the present disclosure based on design priorities. The accompanying method claims provide various operations of elements in a sample order, but it does not mean that the claims are limited to the presented specific order or hierarchical structure.

The description of the presented example embodiments is provided so as for those skilled in the art to use or carry out the present disclosure. Various modifications of the example embodiments may be apparent to those skilled in the art, and general principles defined herein may be applied to other example embodiments without departing from the scope of the present disclosure. Accordingly, the present disclosure is not limited to the example embodiments suggested herein, and shall be interpreted within the broadest meaning range consistent to the principles and new characteristics suggested herein.

What is claimed is:

1. A method of creating a 3D object performed by at least one processor, the method comprising:
obtaining first type data including a filmbox (FBX) file, and second type data including textures, normal maps, metallic information, and roughness information, based on an input 3D asset;
generating a procedural mesh using a first model based on the first type data; and
generating a 3D object using a second model based on the procedural mesh and the second type data.

2. The method of claim 1, wherein the input 3D asset includes a 3D asset that has been decrypted from an encrypted 3D asset, and
wherein the decrypted 3D asset is generated based on an operation of obtaining the encrypted 3D asset from a marketplace and an operation of decrypting the encrypted 3D asset by a client using a secret key.

3. The method of claim 2, wherein the marketplace includes the encrypted 3D asset, and
wherein the encrypted 3D asset includes:
the operation of obtaining the input 3D asset from a 3D modeler; and
the operation of generating the encrypted 3D asset using a public key based on the input 3D asset.

4. The method of claim 3, wherein the operation of generating the encrypted 3D asset using a public key based on the input 3D asset includes generating a 3D asset encrypted with an RSA encryption algorithm using a public key based on the input 3D asset, and
wherein the operation of decrypting the encrypted 3D asset by the client using the secret key includes generating a 3D asset decrypted with an RSA decryption algorithm using a secret key based on the encrypted 3D asset.

5. The method of claim 1, wherein the generating of the procedural mesh using the first model based on the first type data comprises:
extracting a node hierarchy of the 3D object from the FBX file using the first model;
obtaining a transformation matrix based on the node hierarchy;
obtaining, based on the transformation matrix, a procedural coordinate system, and obtaining a procedural texture; and
generating, based on the procedural coordinate system and the procedural texture, the procedural mesh.

6. The method of claim 5, wherein the FBX file includes header data, take data, animation curve data, FBX meshes, and FBX textures.

7. The method of claim 6, wherein the generating a 3D object using a second model based on the procedural mesh and the second type data comprises:
generating a 3D object using the second model based on the procedural mesh and the second type data; and
adjusting shadows and light sources of the 3D object.

8. The method of claim 1, wherein the first model includes Assimp, and
wherein the second model includes Unreal Engine.

9. The method of claim 1, further comprising delivering the 3D object to a terminal including a program related to the 3D project.

10. The method of claim 9, wherein the program related to the 3D project includes an operation of manipulating the 3D object in the runtime environment and an operation of interacting with the 3D object in the runtime environment.

11. A server comprising:
at least one processor; and
a memory,
wherein the at least one processor is configured to:
obtain first type data including an FBX file, and second type data including textures, normal maps, metallic information, and roughness information, based on an input 3D asset;
generate a procedural mesh using a first model based on the first type data; and
generate a 3D object using a second model based on the procedural mesh and the second type data.

12. A non-transitory computer-readable storage medium storing a computer program configured to be executed by at least one processor and cause the at least one processor to perform operations to generate a 3D object, the operations comprising:
obtaining first type data including an FBX file, and second type data including textures, normal maps, metallic information, and roughness information, based on an input 3D asset;
generating a procedural mesh using a first model based on the first type data; and
generating a 3D object using a second model based on the procedural mesh and the second type data.

13. The computer program of claim 12, wherein the input 3D asset includes a 3D asset that has been decrypted from an encrypted 3D asset, and
wherein the decrypted 3D asset is generated based on an operation of obtaining the encrypted 3D asset from a marketplace and an operation of decrypting the encrypted 3D asset by a client using a secret key.
